(19) United States
(12) Patent Application Publication
(10) Pub. No.: US 2006/0288127 A1
(43) Pub. Date: Dec. 21, 2006

(54) Apparatus, system and method capable of wireless communication memory card emulation

(76) Inventors: Shan Greer, Sherwood, OR (US); Rick Johnson, Portland, OR (US); Rob Hamilton, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/154,073

(22) Filed: Jun. 15, 2005

(51) Int. Cl. G06F 3/00

(52) U.S. Cl. 710/5

(57) ABSTRACT

An embodiment of the present invention provides an apparatus, comprising a transmitter, the transmitter capable of emulating a memory card in order to intercept information from an information assimilation device to an associated memory card, and transmitting the information to a separate device with an associated memory slot communicator transmitter/receiver. An embodiment of the present invention may further provide a receiver capable of receiving communication from the associated memory slot communicator transmitter/receiver and the transmitter may have a form factor emulating the memory card. An embodiment of the present invention may also provide a method of information storage comprising, intercepting intended memory card communications between a device and a storage medium associated with the device and transmitting the information to a separate device containing memory and a memory slot communicator transmitter/receiver.

### BACKGROUND

Wireless networks and wireless communication have become prevalent throughout society creating the need for increased capacity and faster and more reliable wireless communication techniques. Further, digital information and the ability to assimilate it have grown exponentially. When information is gathered digitally, the storage of that information can at times be problematic. For example, high resolution digital photography can take large amounts of digital storage for a single picture. Currently, when a digital camera takes a pictures or a mobile computer, such as a personal digital assistant (PDA), stores information, it may be stored in flash memory such as compact flash. Because these devices are small and mobile, typically the physical size of the flash memory must be small in size and therefore with limited storage capacity, thereby limiting, in the digital camera case, the number of pictures one can take.

Further, in the current market, users are forced to share data by moving memory cards from one device to another. Not only does this limit the amount of available memory, but it also does not allow for two devices using the same data simultaneously.

Thus, a strong need exists an apparatus, system and method capable of wireless communication memory card emulation.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates devices that may be utilized and their communication for an embodiment of the present invention; and

FIG. 2 illustrates a flow chart of the method of operation of one embodiment of the present invention.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Some portions of the detailed description that follows are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Embodiments of the present invention may include apparatuses for performing the operations herein. An apparatus may be specially constructed for the desired purposes, or it may comprise a general purpose computing device selectively activated or reconfigured by a program stored in the device. Such a program may be stored on a storage medium, such as, but not limited to, any type of disk including floppy disks, optical disks, compact disc read only memories (CD-ROMs), magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a system bus for a computing device.

The processes and displays presented herein are not inherently related to any particular computing device or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein. In addition, it should be understood that operations, capabilities, and features described herein may be implemented with any combination of hardware (discrete or integrated circuits) and software.

Use of the terms “coupled” and “connected”, along with their derivatives, may be used. It should be understood that these terms are not intended as synonyms for each other. Rather, in particular embodiments, “connected” may be used to indicate that two or more elements are in direct physical or electrical contact with each other. “Coupled” my be used to indicated that two or more elements are in either direct or indirect (with other intervening elements between them) physical or electrical contact with each other, and/or that the two or more elements co-operate or interact with each other (e.g. as in a cause and effect relationship).

It should be understood that embodiments of the present invention may be used in a variety of applications. Although the present invention is not limited in this respect, the devices disclosed herein may be used in many apparatuses such as in the transmitters and receivers of a radio system. Radio systems intended to be included within the scope of the present invention include, by way of example only, cellular radiotelephone communication systems, satellite communication systems, two-way radio communication systems, one-way pagers, two-way pagers, personal communication systems (PCS), personal digital assistants (PDA's), wireless local area networks (WLAN), personal area networks (PAN, and the like).

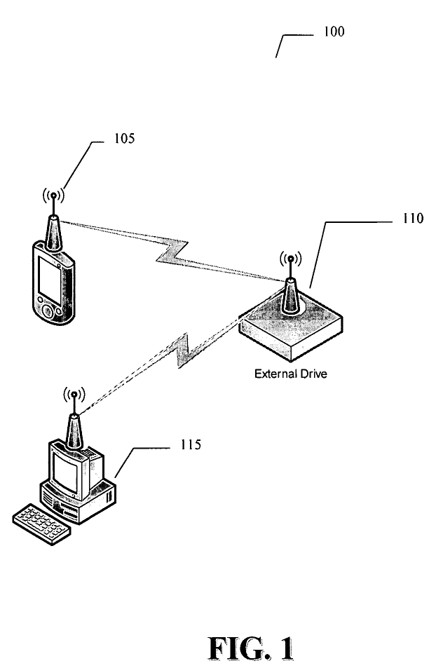

As illustrated in FIG. 1, generally as 100, an embodiment of the present invention provides a wireless communication device 105 that may operate using wireless communication techniques such as a short range wireless standard like the Institute for Electronic and Electrical Engineers (IEE) 802.11a standard capable of 54 Mbs wireless communication. Although not limited in this respect and merely exemplary, the device 105 may be similar in form factor and size to today's Compact Flash Memory adapters. The device may include a transmitter and receiver onboard that may intercept normal memory card communication and transmit it to a computer 115 with an associated memory slot communicator transmitter/receiver 110. The software on this system may decode the communication that came from the device 105 on the other end and transmit an appropriate response.

An embodiment of the present invention may allow a user that is within range of the computer-based transmitter/receiver to take pictures with a digital camera, for example. When the picture is taken and the camera tries to store the image to the Compact Flash or other format memory card, the memory slot communication automatically sends that image, via 802.11a to the transmitter/receive attached to the computer. Again, it is understood that the present invention is not limited to any particular wireless communication technique or standard. The reverse could also happen when the camera tried to retrieve a previously stored image. This would allow a user to store data directly on a computer where the software could allow an unlimited number of devices/users to share that date via 802.11a, 802.11b, Ethernet, etc.

All of this would happen without any special requirements for the primary camera, PDA or other device being used as that device would see the memory slot communication as a standard memory card. It is understood that present invention is not limited to digital cameras, PDAs or other particular devices, but rather is anticipated to be capable of being used for any device where storing of assimilated information is important as the memory slot communication would allow easy sharing of information between devices and allow devices to take advantage of the nearly limitless amount of inexpensive storage available in home computers. Although not limited in this respect, the present invention would be especially convenient for devices that are usually stationary, like picture frames as well as in a photography studio where a user could have the images he/she takes automatically stored and retrieved from a personal computer while still being able to make use of virtually any digital camera on the market.

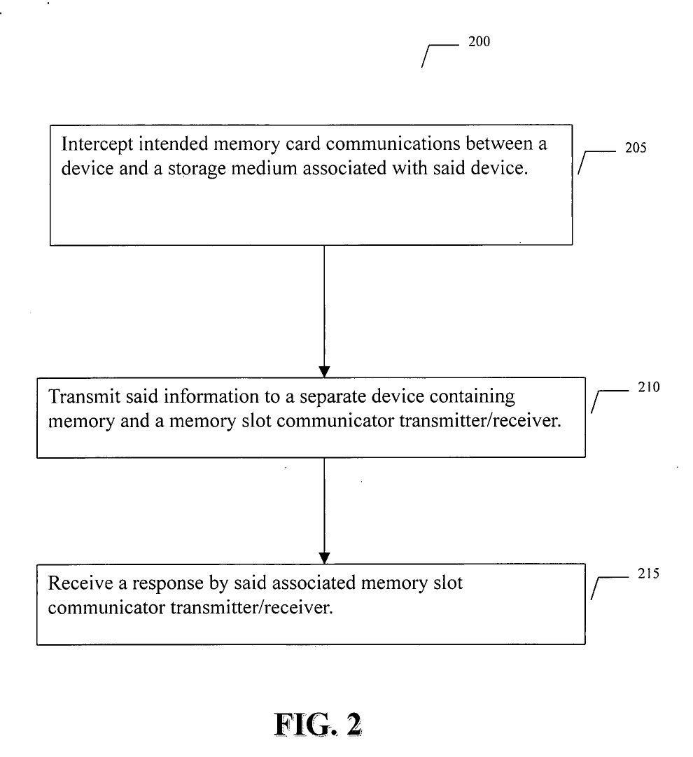

Turning now to FIG. 2, shown generally at 200, is an embodiment of the present invention that provides a method of information storage comprising intercepting intended memory card communications between a device and a storage medium associated with the device 200 and transmitting the information to a separate device containing memory and a memory slot communicator transmitter/receiver 210. The present method further provides receiving a response by the associated memory slot communicator transmitter/receiver 215 and wherein transmitting the information to a separate device may be via a short range wireless communication standard such as, but not limited to, the Institute for Electronic and Electrical Engineering's 802.11a standard adopted prior to Jun. 15, 2005. The method of one embodiment may further comprise transmitting memory card information such that it may be capable of being decoded by the separate device and wherein the separate device is capable of transmitting an appropriate response and the apparatus may be similar in form factor and size to Compact Flash Memory adapters.

Yet another embodiment of the present invention provides an information storage system, comprising an information assimilation device capable of memory card communications; a transmitter connected with the information assimilation device, the transmitter capable of intercepting the memory card communications and transmitting information acquired by the information assimilation device to a separate device with an associated Memory Slot Communicator transmitter/receiver.

An embodiment of the present invention provides an article comprising a machine-accessible medium having one or more associated instructions, which if executed, results in a process for performing the interception of memory card communications between an apparatus and a storage medium associated with the apparatus and transmitting the information to a separate device containing memory storage and a Memory Slot Communicator transmitter/receiver.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. An apparatus, comprising:
a transmitter, said transmitter capable of intercepting information from memory card communications and transmitting said information to a device with an associated memory slot communicator transmitter/receiver.

2. The apparatus of claim 1, wherein said memory card communications are transmissions from an information assimilation device to a memory card slot.

3. The apparatus of claim 1, further comprising a receiver capable of receiving communication from said associated memory slot communicator transmitter/receiver.

4. The apparatus of claim 1, wherein said transmitting from said transmitter is via a short range wireless communication standard.

5. The apparatus of claim 4, wherein said short range wireless communication standard is the Institute for Electronic and Electrical Engineering's 802.11a standard adopted prior to Jun. 15, 2005.

6. The apparatus of claim 1, wherein said transmitter transmits memory card information such that it is capable of being decoded by said device with an associated memory slot communicator transmitter/receiver and wherein said device is capable of transmitting an appropriate response to said apparatus.

7. The apparatus of claim 1, wherein said apparatus is similar in form factor and size to Compact Flash Memory adapters.

8. The apparatus of claim 1, wherein said memory card communication is communication from a digital camera or personal digital assistant (PDA).

9. A method of information storage comprising:
intercepting intended memory card communications between a device and a storage medium associated with said device and transmitting said information to a separate device containing memory and a memory slot communicator transmitter/receiver.

10. The method of claim 9, further comprising receiving a response by said associated memory slot communicator transmitter/receiver.

11. The method of claim 9, wherein said transmitting said information to a separate device is via a short range wireless communication standard.

12. The method of claim 11, wherein said short range wireless communication standard is the Institute for Electronic and Electrical Engineering's 802.11a standard adopted prior to Jun. 15, 2005.

13. The method of claim 9, further comprising transmitting memory card information such that it is capable of being decoded by said separate device and wherein said separate device is capable of transmitting an appropriate response.

14. The method of claim 9, wherein said apparatus is similar in form factor and size to Compact Flash Memory adapters.

15. The apparatus of claim 1, wherein said memory card communication is communication from a digital camera or personal digital assistant (PDA).

16. An information storage system, comprising:
an information assimilation device capable of memory card communications;
a transmitter connected with said information assimilation device, said transmitter capable of intercepting said memory card communications and transmitting information acquired by said information assimilation device to a separate device with an associated Memory Slot Communicator transmitter/receiver.

17. The information storage system of claim 16, wherein said information assimilation device is a digital camera.

18. The information storage system of claim 17, wherein said information assimilation device is a mobile computing device.

19. The system of claim 17, wherein said transmitting from said transmitter is via a short range wireless communication standard.

20. The system of claim 18, wherein said short range wireless communication standard is the Institute for Electronic and Electrical Engineering's 802.11a standard adopted prior to Jun. 15, 2005.

21. The system of claim 16, wherein said transmitter transmits memory card information such that it is capable of being decoded by said separate device with an associated memory slot communicator transmitter/receiver and wherein said separate device is capable of transmitting an appropriate response to said information assimilation device.

22. An article comprising a machine-accessible medium having one or more associated instructions, which if executed, results in a machine performing the interception of memory card communications between an apparatus and a storage medium associated with said apparatus and transmitting said information to a separate device containing memory storage and a Memory Slot Communicator transmitter/receiver.

23. The article of claim 22, where said instructions further results in the reception by said apparatus of communications from said associated memory slot communicator transmitter/receiver.

24. The article of claim 22, where said instructions further results in the transmission of memory card information such that it is capable of being decoded by said separate device and wherein said separate device is capable of transmitting an appropriate response back to said apparatus.

25. An apparatus, comprising:
a transmitter, said transmitter capable of emulating a memory card in order to intercept information from an information assimilation device to an associated memory card, and transmitting said information to a separate device with an associated memory slot communicator transmitter/receiver.

26. The apparatus of claim 24, further comprising a receiver capable of receiving communication from said associated memory slot communicator transmitter/receiver.

27. The apparatus of claim 24, wherein said transmitter has a form factor emulating said memory card.

28. The apparatus of claim 24, wherein said information assimilation device is a digital camera or mobile communication device.
